(19) United States
(12) Patent Application Publication
(10) Pub. No.: US 2022/0061346 A1
(43) Pub. Date: Mar. 3, 2022

(54) FERMENTATION MANAGEMENT METHOD

(71) Applicants: SHARP KABUSHIKI KAISHA, Osaka (JP); CHUBU UNIVERSITY EDUCATIONAL CORPORATION, Kasugai (JP)

(72) Inventors: SHOHEI KOMARU, Osaka (JP); Shunsuke MATSUO, Osaka (JP); Masamitsu MORITANI, Osaka (JP); KOHJI SHINKAWA, Osaka (JP); TADASHI IWAMATSU, Osaka (JP); Haruo NEGISHI, Kasugai (JP)

(21) Appl. No.: 17/407,832

(22) Filed: Aug. 20, 2021

(30) Foreign Application Priority Data
Aug. 26, 2020 (JP) 2020-142692

(51) Int. Cl. A23C 9/123; B08B 9/46; G01N 27/622

(52) U.S. Cl. CPC A23C 9/123; B08B 2209/08; G01N 27/622; B08B 9/46

(57) ABSTRACT

The fermentation management method according to the present invention includes a sampling step of sampling a gas containing substances produced in association with fermentation, an analysis step of analyzing the sampled gas by ion mobility spectrometry, and an operation step of operating at least one of adjustment of the fermentation, termination of the fermentation, mixing of a fermented product, addition of materials or additives to the fermented product, temperature regulation for the fermented product, stirring regulation for the fermented product, firing of the fermented product, sedimentation, and filtration of the fermented product on the basis of at least one of a peak intensity, a peak area, and peak appearance in an IMS spectrum obtained in the analysis step. The analysis step is a step of ionizing and analyzing the substances produced in association with the fermentation by using electrons emitted from an electron emitting element.

### BACKGROUND OF THE INVENTION

### Field of the Invention

The present invention relates to a fermentation management method.

### Description of the Background Art

Various foods such as lactic acid bacteria beverage, yogurt, cheese, liquor, soy sauce, and natto are made by utilizing fermentation. In fermentation, microorganisms produce umami ingredients, sour ingredients, sweet ingredients, flavor ingredients, or the like. Thus, for reducing unevenness in quality of fermented foods, it is necessary to properly determine a fermented state and to properly manage fermentation. Specifically, regulation of temperature, a timing of terminating fermentation, a timing of adding a material, a timing of adding an additive, regulation of stirring, a timing of firing, a timing of sedimentation, and the like are important.

A hydrogen ion concentration measurement using a pH electrode is known as a fermentation management method for an inline of fermented foods such as fermented milk and lactic acid bacteria beverages (e.g., see JP 11-341947 A). A method for measuring a fermented product by an ion mobility spectrometry using a radioactive ion source is known (e.g., see JP 10-510623 W).

Fermentation management by hydrogen ion concentration measurement using a pH electrode has a risk of damage to the pH electrode as well as problems such as difficulty in calibration. In addition, hydrogen ion concentration measurement can only determine a sum of hydrogen ions dissociated from various acids. The ion mobility spectrometry using radioactive ion sources has problems of complicated management of a radiation source and a small ion content.

The present invention has been made in view of such circumstances, and provides a fermentation management method capable of reducing unevenness in quality of the fermented products.

### SUMMARY OF THE INVENTION

The present invention provides a fermentation management method including a sampling step of sampling a gas containing substances produced in association with fermentation, an analysis step of analyzing the sampled gas by ion mobility spectrometry (IMS), and an operation step of operating at least one of adjustment of the fermentation, termination of the fermentation, mixing of a fermented product, addition of materials or additives to the fermented product, temperature regulation for the fermented product, stirring regulation for the fermented product, firing of the fermented product, sedimentation, and filtration of the fermented product on the basis of at least one of a peak intensity, a peak area, and peak appearance in an IMS spectrum obtained in the analysis step, wherein the analysis step is a step of ionizing and analyzing the substances produced in association with the fermentation by using electrons emitted from an electron emitting element.

In the sampling step, the gas containing the substances produced in association with the fermentation is sampled. Thereby, fermentation can also be managed using analysis results of a gas in a headspace of a fermented product container, and the like, so that fermentation can be quickly and easily managed. No matter whether the fermented product is a liquid, a past, or a solid, fermentation can be managed. In addition, a risk of foreign matter contamination in the fermented product can be reduced. In the analysis step, the sampled gas is analyzed by the ion mobility spectrometry using the electron emitting element. Thus, the gas containing the substances produced in association with the fermentation can be easily and continuously analyzed, so that it is possible to determine change in an amount of the substances produced in association with the fermentation can be determined by monitoring changes in a peak intensity or a peak area in the IMS spectrum. Also, change in an amount of a single substance produced in association with the fermentation can be measured. Specifically, in the analysis step, change in an amount of each acid produced in association with the fermentation can be measured. Also, change in an amount of the aroma ingredient involved in taste, such as diacetyl and acetaldehyde can be measured. In addition, the ion content in the analysis device can be increased by using an electron emitting element, and a detection sensitivity of the IMS can be improved.

In the operation step, adjustment, termination, and the like of the fermentation are conducted on the basis of a peak intensity, a peak area, or peak appearance in the IMS spectrum. Thus, adjustment, termination, and the like of the fermentation can be quickly conducted at an appropriate timing, and unevenness in quality of the fermented products can be reduced.

### BRIEF DESCRIPTION OF THE DRAWINGS

FIG. 1 is a schematic sectional view of a fermentation product container and an ion mobility spectrometer that are used in a fermentation management method according to an embodiment of the present invention.

FIG. 2 is a schematic sectional view of an electron emitting element and a counter electrode.

FIG. 3 presents IMS spectra obtained by analyzing humidified air.

FIG. 4 presents IMS spectra obtained by analyzing a gas containing substances produced in association with yogurt fermentation.

FIG. 5 presents IMS spectra obtained by analyzing gases containing Lot A, Lot B or a produced substance obtained by formulating Lots A and B.

FIG. 6 presents IMS spectra under a normal state and an abnormal state.

FIG. 7 presents IMS spectra 1 hour, 2 hours, and 3 hours after start of the fermentation.

FIG. 8 is a graph presenting change in pH and change in an IMS intensity of an organic acid peak in yogurt during the fermentation.

FIG. 9 is a graph presenting a relationship between an element driving voltage and a current that flows by emitting electrons from the electron emitting element.

FIG. 10 presents an IMS spectrum obtained by analyzing humidified air.

### DESCRIPTION OF THE PREFERRED EMBODIMENTS

The fermentation management method according to the present invention includes a sampling step of sampling a gas containing substances produced in association with fermentation, an analysis step of analyzing the sampled gas by ion mobility spectrometry, and an operation step of operating at least one of adjustment of the fermentation, termination of the fermentation, mixing of a fermented product, addition of materials or additives to the fermented product, temperature regulation for the fermented product, stirring regulation for the fermented product, firing of the fermented product, sedimentation, and filtration of the fermented product on the basis of at least one of a peak intensity, a peak area, and peak appearance in an IMS spectrum obtained in the analysis step, wherein the analysis step is a step of ionizing and analyzing the substances produced in association with the fermentation by using electrons emitted from an electron emitting element.

Preferably, the operation step includes a step of determining an operation timing by comparing the peak intensity, the peak area, or the peak appearance in the IMS spectrum obtained in the analysis step with previously measured measurement data on the relationship between a fermented state of the fermented product and the IMS spectrum. This makes it possible to conduct the treatments at appropriate timings and to properly manage the fermented product.

The fermentation includes anaerobic fermentation, and thereby the anaerobic fermentation can be properly managed.
The sampling step is preferably a step of sampling the gas in the fermented product container. This facilitates sampling of the substances produced in association with fermentation.

The fermentation management method according to the present invention preferably includes a step of removing the fermented product in the fermented product container to put a detergent liquid into the fermented product container, and a step of flowing the gas in a headspace of the fermented product container containing the detergent liquid into the analysis device for the ion mobility spectrometry. Thereby, a gas adsorbed on a piping, the electron emitting element, and a reaction chamber can be removed, and analysis accuracy of the ion mobility spectrometry can be improved.

Preferably, the fermentation management method according to the present invention includes a washing step of removing the fermented product in the fermented product container to wash the fermented product container, and a washing validation step conducted after the washing step. In the washing validation step, the gas inside the fermented product container after washing is analyzed by the ion mobility spectrometry to validate that the peak intensity or peak area attributed to the residual fermented product or residual detergent is equal to or less than a permissible residual value. This makes it possible to prevent the residual fermented product and detergent in the fermented product container from affecting the quality of the product.

Preferably, the electron emitting element is configured to have a lower electrode, a surface electrode, and an intermediate layer disposed between the lower electrode and the surface electrode, and emit electrons by applying a voltage between the lower electrode and the surface electrode. Thereby, an amount of the ions generated in the reaction chamber of the ion mobility spectrometer can be increased to improve analysis accuracy. The intermediate layer has a thickness of preferably 0.5 μm or larger to 2 μm or smaller, and the voltage applied between the lower electrode and the surface electrode in the analysis step is preferably 8 V or higher to 16 V or lower. This makes it possible to improve the analysis accuracy of the ion mobility spectrometry.

It is preferable to regulate the voltage applied between the lower electrode and the surface electrode on the basis of the IMS spectrum in the analysis step. By such feedback control, the amount of the ions generated by the electrons emitted from the electron emitting element can be constantly maintained to perform quantitative measurements.

Preferably, the fermentation management method according to the present invention includes a step of regulating the voltage to be applied between the lower electrode and the surface electrode on the basis of the IMS spectrum obtained by analyzing humidified air. Thereby, the amount of the ions generated by the electrons emitted from the electron emitting element can be constantly maintained.

Hereinafter, the present invention will be explained in more detail with reference to a plurality of embodiments. The accompanying drawings and the description below merely illustrate exemplary configurations, to which the scope of the present invention is in no way limited.

### First Embodiment

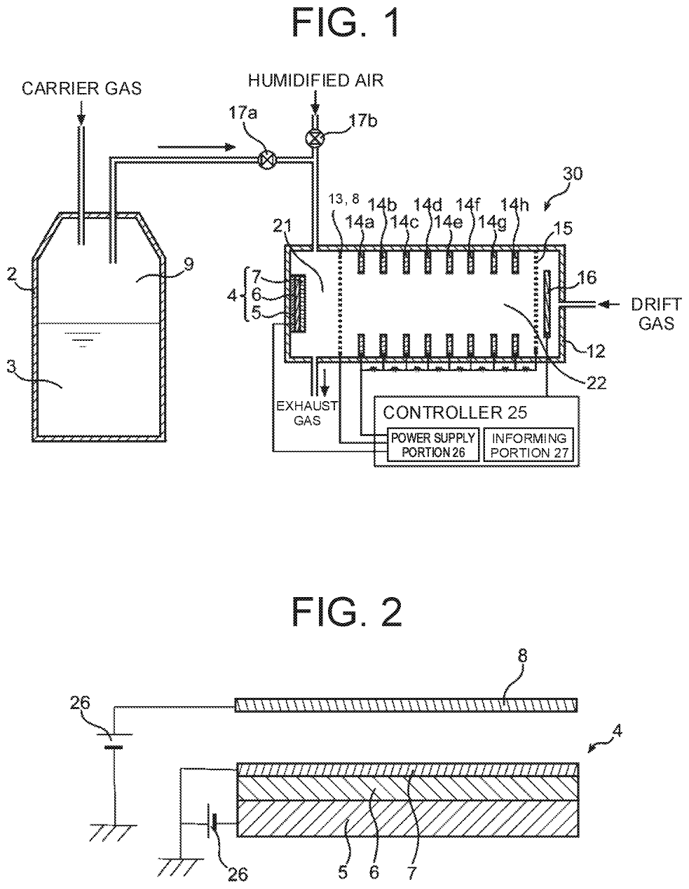

FIG. 1 is a schematic sectional view of the fermented product container and the ion mobility spectrometer that are used in the fermentation management method according to the first embodiment.
The fermentation management method according to the first embodiment includes a sampling step of sampling a gas containing substances produced in association with fermentation, an analysis step of analyzing the sampled gas by ion mobility spectrometry, and an operation step of operating at least one of adjustment of the fermentation, termination of the fermentation, mixing of a fermented product 3, addition of materials or additives to the fermented product 3, temperature regulation for the fermented product 3, stirring regulation for the fermented product 3, firing of the fermented product 3, sedimentation, and filtration of the fermented product 3 on the basis of at least one of a peak intensity, a peak area, and peak appearance in an IMS spectrum obtained in the analysis step, wherein the analysis step is a step of ionizing and analyzing the substances produced in association with the fermentation by using electrons emitted from an electron emitting element 4.

The fermentation management method according to the first embodiment is intended to perform adjustment of the fermentation, termination of the fermentation, mixing of the fermented product 3, addition of materials or additives to the fermented product 3, temperature regulation for the fermented product 3, stirring regulation for the fermented product 3, firing of the fermented product 3, sedimentation, or filtration of the fermented product 3, at appropriate timings, in the production or fermentation method of the fermented product 3. The fermentation management method may be a method for managing anaerobic fermentation or aerobic fermentation.

The fermented product 3 is e.g., a fermented food such as a lactic acid bacteria beverage, yogurt (fermented milk), cheese, liquor, soy sauce, and natto. In addition, fermentation methods are used e.g., in production of an amino acid, a vitamin, an antibiotic, an enzyme, and a bioethanol, or the like.

In fermentation, microorganisms produce umami ingredients, sour ingredients, sweet ingredients, flavor ingredients, useful substances, or the like. Some of these produced substances (organic substances) evaporate or volatilize and are emitted as a gas from the fermented product 3. Since the amount and types of the produced substances vary depending on the fermented state of the fermented product 3, the fermented state of the fermented product 3 can be examined by analyzing the produced substances emitted as the gas.

In the sampling step, the gas containing the substances produced in association with the fermentation (produced substances) are sampled. Since the produced substances emitted from the fermented product 3 normally accumulates in a headspace 9 of the fermented product container 2, the gas in the headspace 9 of the fermented product container 2 can be sampled in the sampling step. The fermented product container 2 is e.g., a fermented product tank, a fermented product barrel, or the like. The fermented product tank may be a tank having a sealed structure or a tank covered by a lid. The sampling step may be a step of sampling a gas in a fermentation chamber containing natto, cheese or the like. The sampling step may be a step in which a gas (sample gas) containing substances produced in association with fermentation is continuously sampled and fed into an ion mobility spectrometer 30, or may be a step in which a gas containing substances produced in association with fermentation is sampled at measurement intervals (e.g. every 3 minutes) and fed into the ion mobility spectrometer 30.

When the fermented product container 2 has a sealed structure, e.g., it is possible to provide an inlet through which a carrier gas flows into the headspace 9 of the fermented product container 2, and an outlet through which the carrier gas and the produced substances flow out of the headspace 9. In the sampling step, the gas (carrier gas+produced substances) that has flowed out of this outlet can be fed into the ion mobility spectrometer 30. This makes it possible to sample the produced substances in the headspace 9 to repeatedly analyze the produced substances using the ion mobility spectrometer 30. Preferably, the carrier gas is air, or filtered pure air. In the sampling step, the gas in the fermented product container 2 or the fermentation chamber may be sucked using a sampling pump or a fan and then fed into the ion mobility spectrometer 30.

A humidity of the gas to be fed into the ion mobility spectrometer 30 is preferably 5% or higher. Thereby, a humidity of a reaction chamber 21 of the ion mobility spectrometer 30 can be 5% or higher, and an electron emission quantity of the electron emitting element 4 as the ion source can be increased.

In the analysis step, the produced substances sampled in the sampling step are analyzed using the ion mobility spectrometer 30. The ion mobility spectrometer 30 used in the analysis step may be a device for analysis using a drift tube-style IMS, or a device for analysis using a field asymmetric-style IMS (FAIMS). In the first embodiment, the device for analysis using the drift tube-style IMS will be explained.

The ion mobility spectrometer 30 has an electron emitting element 4 as an ion source, and in the ion mobility spectrometry, the sampled produced substances are ionized using the electrons emitted from the electron emitting element 4. In addition, the ion mobility spectrometer 30 is controlled by a controller 25. The controller 25 may control a valve 17a, the sampling pump, and the like to control a timing of sampling the gas in the sampling step. The controller 25 can include e.g., a microcontroller having a CPU, a memory, a timer, an input/output port, and the like. Also, the controller 25 can include a power supply portion 26, an informing portion 27, and the like. In addition, the controller 25 is configured so as to control the electron emission of the electron emitting element 4 and the electrical opening/closing of a gate electrode 13.

The ion mobility spectrometer 30 has the reaction chamber 21 (between the electron emitting element 4 and the gate electrode 13) for ionizing the produced substances sampled in the sampling step, and a drift region 22 (between the gate electrode 13 and the ion detector 16) for transferring the ions (anions) generated in the reaction chamber 21 toward an ion detector 16 to separate the ions. The drift region 22 is a region where a potential gradient (electric field) is formed by a plurality of annular separation electrodes 14a to 14h, and the ions move from the gate electrode 13 to the ion detector 16 due to this potential gradient.

The reaction chamber 21 and the drift region 22 are partitioned from each other by the gate electrode 13 (grid electrode). An electron emitting element 4 is disposed on an end opposite to the gate electrode 13 of the reaction chamber 21 such that a surface electrode 7 is disposed on the side of the reaction chamber 21. Thus, the gate electrode 13 serves as a counter electrode 8 for the electron emitting element 4. The ion detector 16 is disposed on the end opposed to the gate electrode 13 of the drift region 22.

When the produced substances sampled in the sampling step enter the reaction chamber 21 together with the carrier gas from a sample inlet, the produced substances pass through the reaction chamber 21 between the electron emitting element 4 and the gate electrode 13 and are ionized by charges resulting from the electrons emitted from the electron emitting element 4. The carrier gas and non-ionized gases, and the like are exhausted together with the drift gas through an exhaust port disposed on the lateral side of the reaction chamber 21.

The drift gas from which impurities such as dry gas are removed is introduced into a housing 12 of the ion mobility spectrometer 30 from a drift gas inlet on the ion detector 16 side, then flows through the drift region 22 from the ion detector 16 side to the gate electrode 13 side, then flows into the reaction chamber 21, and the drift gas is exhausted together with the carrier gas from the exhaust port. The drift gas is preferably dry nitrogen or air that has passed through a desiccant. For reducing the impurities in the drift gas, it is preferable that the drift gas is passed through a filter before introduction.

The electron emitting element 4 is configured to emit electrons from the surface electrode 7 and is intended to directly or indirectly ionize the produced substances by the electrons emitted in the atmosphere to generate ions.

The electron emitting element 4 includes a lower electrode 5, the surface electrode 7, and an intermediate layer 6 disposed between the lower electrode 5 and the surface electrode 7.

The surface electrode 7 is located on the surface of the electron emitting element 4. The surface electrode 7 can have a thickness of preferably 10 nm or larger to 100 nm or smaller. A material for the surface electrode 7 is e.g., gold or platinum. In addition, the surface electrode 7 may be composed of a plurality of metal layers.

The lower electrode 5 is opposed to the surface electrode 7 via the intermediate layer 6. The lower electrode 5 may be a metal plate, or a metal layer or conductor layer that is formed on an insulating substrate or a film. When the lower electrode 5 is composed of a metal plate, the metal plate may be a substrate of the electron emitting element 4. Examples of the material for the lower electrode 5 include aluminum, stainless steel, and nickel. The lower electrode 5 has a thickness of e.g., 200 μm or larger to 1 mm or smaller.

The intermediate layer 6 is a layer through which electrons flow due to an electric field generated by applying a voltage to the surface electrode 7 and the lower electrode 5. The intermediate layer 6 can be semiconductive. The intermediate layer 6 can contain at least one of an insulating resin, insulating fine particles, and a metal oxide. Preferably, the intermediate layer 6 contains metal fine particles such as silver fine particles. The intermediate layer 6 can have a thickness of e.g. 0.5 μm or larger to 2.0 μm or smaller.

The surface electrode 7 and the lower electrode 5 are each electrically connectable with the controller 25. A voltage is applied between the lower electrode 5 and the surface electrode 7 by using the power supply portion 26 of the controller 25, so that a current flows through the intermediate layer 6, and the electrons that have flowed through the intermediate layer 6 pass through the surface electrode 7 and then are emitted into the reaction chamber 21. The voltage applied between the lower electrode 5 and the surface electrode 7 for emitting electrons from the electron emitting element 4 can be e.g., 8 V or higher to 16 V or lower.

The electrons emitted from the electron emitting element 4 into the reaction chamber 21 at atmospheric pressure negatively ionize gas molecules (e.g., oxygen molecules, water molecules, produced substances, and the like) by electron attachment. When there are a trace amount of produced substances in the reaction chamber 21 (air+produced substances), the produced substances are rarely ionized directly, and most produced substances are ionized indirectly via air ions (e.g. oxygen molecules, water molecules, and the like). The generated anions are introduced to the gate electrode 13 (counter electrode 8) set to a higher voltage than of the surface electrode 7. When generating anions in air, electron attachment can be caused by emitting electrons having an energy of several eV to generate anions.

For example, the controller 25 can apply a voltage to the lower electrode 5, the surface electrode 7, and the counter electrode 8 (gate electrode 13), as illustrated in FIG. 2.

The gate electrode 13 partitions the reaction chamber 21 and the drift region 22 from each other and controls the injection of the anions generated in the reaction chamber 21 into the drift region 22 by using an electrostatic interaction between the anions and the gate electrode 13. Also, the gate electrode 13 serves as a counter electrode 8 (induction electrode) for the electron emitting element 4.

The gate electrode 13 may be a ring-shaped electrode, a grid electrode, or an electrode in which the grid electrode is disposed on an opening of the ring-shaped electrode. The gate electrode 13 is preferably a grid electrode. The gate electrode 13 can be arranged in line together with the plurality of annular separation electrodes 14a to 14h that form a potential gradient (electric field) in the drift region 22. The gate electrode 13 can be electrically connected to the controller 25, and the controller 25 changes the potential of the gate electrode 13 to control the potential of the gate electrode 13 such that the gate electrode 13 can be switched between an opened state and a closed state.

For example, if the potential of the gate electrode 13 is low, the anions in the reaction chamber 21 cannot approach the gate electrode 13 due to the electrostatic interaction (a force in a direction repulsive against the gate electrode 13 acts on the anions), and accordingly cannot pass through the gate electrode 13. Consequently, the gate electrode 13 is turned to the closed state (lower potential-side close).

For example, if the potential of the gate electrode 13 is high, the anions in the reaction chamber 21 move as if attracted to the gate electrode 13 and come into contact with the gate electrode 13, so that the charges of the anions move to the gate electrode 13 to neutralize the anions. Thus, the anions cannot pass through the gate electrode 13 and the gate electrode 13 is turned to the closed state (higher potential-side close).
For example, if the gate electrode 13 is at an intermediate potential between the lower potential-side close and the higher potential-side close, the anions in the reaction chamber 21 can pass through the gate electrode 13 and the gate electrode 13 is turned to the opened state.

When the controller 25 changes the potential of the gate electrode 13 such that the gate electrode 13 is instantaneously changed in a manner of the higher potential-side close→open→the lower potential-side close or such that the gate electrode 13 is instantaneously changed in a manner of the lower potential-side close→open→the higher potential-side close, the gate electrode 13 can be opened for a very short time, and the anions in the reaction chamber 21 can be injected into the drift region 22 only for this short time. Consequently, the anions in the reaction chamber 21 can be injected in a form of a single pulse, into the drift region 22.

The anions injected into the drift region 22 by the gate electrode 13 move through the drift region 22 toward the ion detector 16 due to the potential gradient generated by the separation electrodes 14a to 14h, and reach the ion detector 16. The potentials of the separation electrodes 14a to 14h are controlled by the controller 25.

The anions that have reached the ion detector 16 hand over the charges to the ion detector 16 to become neutral. The ion detector 16 and the controller 25 measure a current generated when the ion detector 16 receives the charges, and output the current as the IMS spectrum. Specifically, a flying time of the ions from the instantaneous opening of the gate electrode 13 to the arrival of the ions at the ion detector 16 is plotted on an abscissa, and a signal intensity (amperage) is plotted on an ordinate to obtain an ion mobility spectrum (IMS spectrum).

In the drift region 22, the drift gas flowing from the ion detector 16 toward the gate electrode 13 becomes a resistance for the anions moving from the gate electrode 13 toward the ion detector 16. A magnitude of the resistance (ion mobility) depends on ion species. In general, the mobility is inversely proportional to a collision cross-section area of the ions, and therefore the larger the ion collision cross-section area is, the longer the time required for the ions to arrival at the ion detector 16. Thus, the time from the injection of the ions into the drift region 22 by the gate electrode 13 to the arrival at the ion detector 16 (moving time, peak position) depends on the ion species of the anions. Thereby, the plural species of anions injected into the drift region 22 from the gate electrode 13 are separated while moving through the drift region 22 and arrive at the ion detector 16 with a time lag.

Since the IMS spectrum corresponds to the amount of the ions that have arrived at the ion detector 16, the IMS spectrum shows peaks corresponding to various anions. Then, the anions (produced substances) can be identified on the basis of the peak position (moving time). The change in the amount of the anions (produced substances) can be monitored by repeating the measurement. The peak intensity (peak height) or peak area of the peak appearing in the IMS spectrum corresponds to the amount of the produced substances. The IMS spectrum also shows a peak of the ions generated from air as the carrier gas.

For example, if the fermented product is yogurt (bifidobacterium fermentation), milk containing a bifidobacterium as an inoculum is maintained in the fermented product tank at a fermentation temperature (e.g., around 40° C.) for about 24 to 48 hours. Thereby, the fermentation proceeds, and the bifidobacterium produces lactic acid, acetic acid, and the like from sugars contained in milk. Also, other substances such as an aroma ingredient are produced in association with the fermentation. In the sampling step, the gas in the headspace of the fermented product tank is sampled, and in the analysis step, the analysis is performed to obtain an IMS spectrum, so that the IMS spectrum shows a peak of the carrier gas component (oxygen molecules, water molecules, and the like), a peak of lactic acid, a peak of acetic acid, a peak of the aroma ingredient, and the like.

As the fermentation proceeds, the amount of the produced substances (lactic acid, acetic acid, aroma ingredient, and the like) in the fermented product 3 increases, and therefore, as IMS spectra are repeatedly obtained during the fermentation, the peak intensity (peak height) and peak area of the produced substances gradually increase. In addition, as the fermentation proceeds, the IMS spectrum shows new peaks in some cases.

In the operation step, adjustment of the fermentation, termination of the fermentation, mixing of the fermented product 3, addition of materials or additives to the fermented product 3, temperature regulation for the fermented product 3, stirring regulation for the fermented product 3, firing of the fermented product 3, sedimentation, or filtration of the fermented product 3 are performed on the basis of the peak intensity, the peak area, or the peak appearance of the IMS spectrum obtained in the analysis step. The operations performed in the operation step depend on the type of fermented product 3 and the IMS spectrum obtained in the analysis step. In the operation step, on the basis of the peak intensity, the peak area, or the peak appearance of the IMS spectrum, the controller 25 informs an operator via the informing portion 27, and the operator operates to perform the operation step. If manufacture of the fermented product 3 is automated or partially automated, the controller 25 may control the manufacture device to perform the operation step.

Herein, the fermented product 3 is yogurt (bifidobacterium fermentation), and a case that the fermentation is terminated in the operation step will be explained. Since, bifidobacteria produce organic acids such as lactic acid and acetic acid in yogurt fermentation, sourness gradually becomes stronger as the fermentation proceeds. It is important to terminate the fermentation at the appropriate timing for making yogurt having a moderate sourness. For example, the fermentation can be terminated by cooling yogurt to 10° C. or lower.

As the amount of lactic acid and acetic acid in yogurt increases in association with progress of the fermentation, the pH of yogurt gradually decreases. This makes it possible to monitor the fermented state of yogurt using a pH electrode to determine a timing for terminating the fermentation on the basis of the pH. However, since the pH electrode is readily broken, there is a risk that yogurt is contaminated by foreign matters due to breakage of the pH electrode. In addition, the pH electrode is difficult to calibrate.

As the amount of lactic acid and acetic acid in the yogurt increases in association with progress of the fermentation, the peak intensities of lactic acid and acetic acid in the IMS spectrum obtained in the analysis step gradually increase.
Thus, there is a correlation between the peak intensities of the organic acids such as lactic acid and acetic acid in the IMS spectrum obtained in the analysis step and the pH of yogurt. Thus, the pH of yogurt can be calculated from the peak intensities of the organic acids such as lactic acid and acetic acid in the IMS spectrum by using measurement data of this correlation determined in advance.

In the operation step, the timing for each operation can be determined by comparing the peak intensity or peak area in the IMS spectrum obtained in the analysis step with the measurement data of the correlation between the fermented state of the fermented product and the IMF spectrum determined in advance.

For example, it is previously performed to determine measurement data showing the correlation between change in the peak intensity of lactic acid (reference substance) in the IMS spectrum obtained in the analysis step in the yogurt fermentation and change in the pH of yogurt measured using the pH electrode. Then, if it is intended to terminate the fermentation when the pH of yogurt is 4.6, the peak intensity of lactic acid corresponding to pH 4.6 is calculated from the measurement data. When the peak intensity (recovery current) of lactic acid is 530 pA, the peak intensity of lactic acid gradually increases as the IMS spectrum in the analysis step is repeatedly measured during the yogurt fermentation, and when the peak intensity of lactic acid reaches 530 pA, the yogurt fermentation is terminated.
When the fermentation does not smoothly proceed, a ratio of the peak intensity in the IMS spectrum with respect to the fermentation time is changed, and therefore quality of the fermentation can be determined at an early stage by monitoring transition in the peak intensity.

In this way, termination of the fermentation or the like can be quickly performed at an appropriate timing, and unevenness in the quality of the fermented food can be reduced by determining the operation timing on the basis of the peak intensity in the IMS spectrum obtained by analyzing the gas containing the substances produced in association with the fermentation. In addition, since the fermented product 3 cannot be directly sampled and a measuring instrument cannot be inserted into the fermented product 3, the foreign matter contamination of the fermented product 3 can be prevented.

Herein, although the present invention has been explained using the peak intensity in the IMS spectrum, the operation timing can be similarly determined also using the peak area in the IMS spectrum.
In addition, although the operation timing has been determined using the peak intensity of lactic acid herein, the operation timing may be determined using the peak intensity of acetic acid. Also, the operation timing may be determined using both the peak intensity of lactic acid and the peak intensity of acetic acid.
In the IMS, the mobility is used as a measurement principle, and therefore different substances have the same mobility, and their peaks overlap in some cases. Even if the peak is such a composite peak of plural substances, the operation timing of the fermentation termination or the like can be determined using this composite peak as long as the correlation of the peak with the fermented state has been previously validated.

### Second Embodiment

A fermentation management method according to the second embodiment includes a step of removing the fermented product 3 in the fermented product container 2 to put a detergent liquid into the fermented product container 2, and a step of flowing the gas in the headspace 9 of the fermented product container 2 containing the detergent liquid into the ion mobility spectrometer 30. As in these steps, instead of the fermented product 3, the detergent liquid is put into the container and the gas in the headspace is flowed into the analysis device 30, so that the gas adsorbed on the piping, the electron emitting element 4, and the reaction chamber 21 can be removed. As a result, the analysis accuracy of the ion mobility spectrometry can be improved.
The detergent liquid is e.g., a washing substance that easily dissolve the adsorbed substance, such as pure water and ethanol.

During the step that the gas in the headspace 9 of the fermented product container 2 containing the detergent liquid is flowed into the ion mobility spectrometer 30, the controller 25 preferably terminates the voltage application between the lower electrode 5 and the surface electrode 7. In the electron emitting element 4, the amperage (current in the element) between the lower electrode 5 and the surface electrode 7 is changed depending on the gas species of the atmosphere, and therefore an overcurrent flows through the electron emitting element 4 in some cases. The termination of the voltage application can prevent the overcurrent from flowing through the electron emitting element 4.

Preferably, the fermentation management method according to the second embodiment includes a step of flowing the gas in the headspace 9 of the fermented product container 2 containing the detergent liquid into the ion mobility spectrometer 30, a subsequent step of removing the detergent liquid in the fermented product container 2, and a step of flowing the carrier gas alone into the ion mobility spectrometer 30. By flowing the carrier gas alone, the detergent liquid on the element surface can be removed. This makes it possible to prevent the overcurrent from flowing during application of the element driving voltage due to the detergent liquid adsorbed on the surface of the electron emitting element 4.

The other configurations are the same as in the first embodiment. The description on the first embodiment applies to the second embodiment unless any contradictions occur.

### Third Embodiment

The fermentation management method according to the third embodiment includes a step of regulating the voltage applied between the lower electrode 5 and the surface electrode 7 on the basis of the IMS spectrum obtained by analyzing the humidified air according to the ion mobility spectrometry. Also when a voltage (element driving voltage) is applied between the lower electrode 5 and the surface electrode 7 of the electron emitting element 4 under the same voltage application condition, an amount of air ions generated by electrons emitted from the electron emitting element 4 fluctuates depending on environmental conditions such as temperature and humidity and a life time property of the element. For this reason, the ionization capability of the ion mobility spectrometer 30 fluctuates depending on the environmental conditions, the life time property, or the like, and the analysis results are not stabilized. Thus, the element driving voltage is regulated on the basis of the IMS spectrum at the time of humidified air measurement, so that the amount of the ions generated by electrons emitted from the electron emitting element 4 can be constantly maintained.

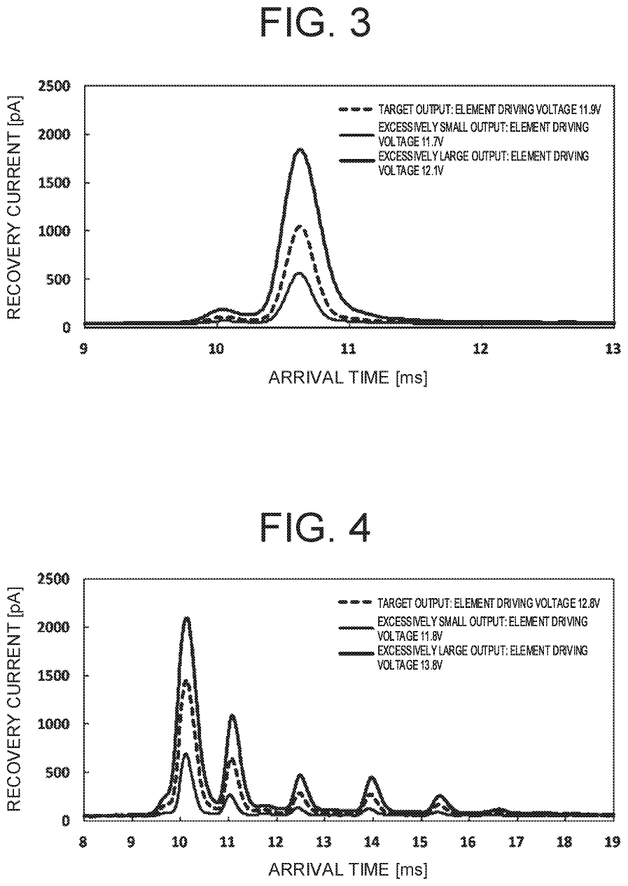

Three IMS spectra obtained by analyzing humidified air according to the ion mobility spectrometry are presented in FIG. 3. The three IMS spectra were obtained by measurements under the same condition except that the element driving voltage was changed. Peaks of the three IMS spectra at about 10.6 millisecond point are peaks of ionized air (e.g., oxygen molecule ions). The peak height (peak intensity) or the peak area represents the amount of ionized air that has arrived at the ion detector 16 (corresponding to the amount of the ions generated by the electrons emitted from the electron emitting element 4), and serves as an indicator for regulating the element driving voltage.

As indicated in the three IMS spectra in FIG. 3, the peak intensity and the peak area of the ionized air peak greatly change by changing the element driving voltage.

For the regulation of the element driving voltage, prior to the sampling step of sampling the fermentation produced substances, measurement of air at constant humidity is repeated while changing the element driving voltage, and the element driving voltage is regulated such that the peak height or the peak area of ionized air is within a target range. Specifically, if the peak height or the peak area is smaller than the lower limit of the target range, the element driving voltage is increased, and if the peak height or peak area is larger than the upper limit of the target range, the element driving voltage is decreased.

Preferably, humidified air to be analyzed for regulating the voltage applied between the lower electrode 5 and the surface electrode 7 has the same humidity as of the gas to be analyzed in the analysis step. As a method for introducing air into the ion mobility spectrometer, water vapor obtained by putting water into the fermented product container 2 and vaporizing water may be introduced together with a carrier gas into the ion mobility spectrometer, or humidified air may be introduced into the way of the sample gas line after opening a valve 17b in FIG. 1.

Configurations other than those described above are the same as the first or second embodiment. The description on the first or second embodiment applies to the third embodiment unless any contradictions occur.

### Fourth Embodiment

In the third embodiment, the voltage to be applied between the lower electrode 5 and the surface electrode 7 was regulated before the sampling step of sampling the fermentation produced substances, but in the fermentation management method according to the fourth embodiment, the voltage to be applied between the lower electrode 5 and the surface electrode 7 is regulated (feedback control is conducted) on the basis of the IMS spectrum in the analysis step of analyzing the fermentation produced substances.
FIG. 4 presents three IMS spectra obtained by analyzing a gas containing a substance produced in association with yogurt fermentation according to the ion mobility spectrometry. The three IMS spectra were obtained by measurements under the same condition except that the element driving voltage was changed. The three IMS spectra show five peaks (excluding fine peaks). These five peaks can serve as indicators for regulating the element driving voltage. As indicated in the three IMS spectra in FIG. 4, the peak intensities and the peak areas of the five peaks greatly change by changing the element driving voltage.

In the fourth embodiment, in the analysis step, the analysis of the produced substance is repeated while regulating the element driving voltage such that a total peak area of the peaks appearing in the IMS spectrum obtained by repeating the analysis of the produced substance is substantially constant (within the target range).

Specifically, if the total peak area of the peaks appearing in the IMS spectrum is smaller than the lower limit of the target range, the amount of the ions generated by the electrons emitted from the electron emitting element 4 is constantly maintained by increasing the element driving voltage such that the total peak area is within the target range.
If the total peak area of the peaks appearing in the IMS spectrum is larger than the upper limit of the target range, the amount of the ions generated by the electrons emitted from the electron emitting element 4 is constantly maintained by decreasing the element driving voltage such that the total peak area is within the target range. In this way, in the analysis step, the feedback control for adjusting the element driving voltage is conducted on the basis of the total peak area of the peaks appearing in the IMS spectrum.
Thereby, the analysis device can be operated so as to keep maintaining the total peak area constant, and a quantitative measurement becomes possible. Configurations other than those described above are the same as the first through the third embodiments. The description on the first through the third embodiments applies to the fourth embodiment unless any contradictions occur.

### Fifth Embodiment

In the fermentation management method according to the fifth embodiment, the operation step is a step in which the fermented product 3 is mixed on the basis of the peak intensity or the peak area of the aroma ingredient in the IMS spectrum obtained in the analysis step of analyzing the fermentation produced substances. For example, when the same fermented foods are manufactured in a plurality of lots, the sampling step and the analysis step are performed in the manufacture device of each lot to obtain an IMS spectrum. Then, the plurality of lots are mixed on the basis of the peak intensity or the peak area of the aroma ingredient in the obtained IMS spectrum. This makes it possible to stably maintain the quality of the fermented food. In addition, use of the data of the aroma ingredient quantified according to the IMS spectrum allows precise formulation.

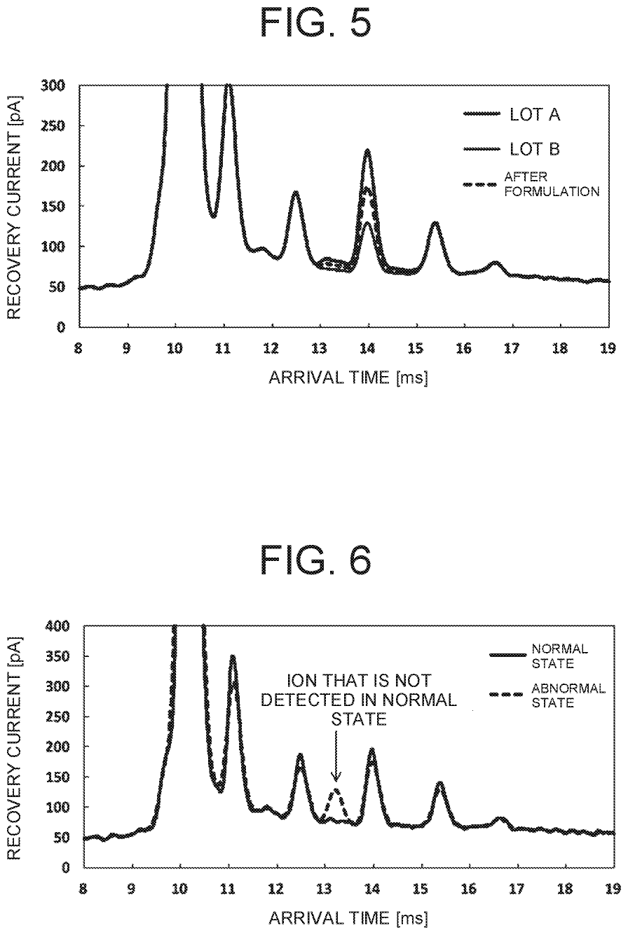

For example, if the peak intensity at 14 millisecond point differs between Lot A and Lot B as illustrated in FIG. 5, a concentration of the aroma ingredient detected at 14 millisecond point is quantified, and Lot A and Lot B are mixed in an appropriate ratio to adjust the concentration of the aroma ingredient at 14 millisecond point.

Configurations other than those described above are the same as the first through the fourth embodiments. The description on the first through the fourth embodiments applies to the fifth embodiment unless any contradictions occur.

### Sixth Embodiment

In the fermentation management method according to the sixth embodiment, in the operation step, termination of the fermentation or adjustment of the fermentation are performed on the basis of an abnormal peak appearance and an abnormal peak intensity ratio in the IMS spectrum obtained by analyzing the fermentation produced substances (analysis step).
A storage of the controller 25 stores information under a normal state, such as a peak appearance time, a manner of increase in the peak intensity, a peak position (arrival time), and a peak intensity ratio of a plurality of main peaks in the IMS spectrum during the fermentation process where the fermented product 3 is normally fermented.

Once the IMS spectrum is obtained in the analysis step, the obtained IMS spectrum is compared with the information under the normal state stored in the storage. When the controller 25 judges fermentation abnormality, the controller 25 informs the operator the abnormality via the informing portion 27, and the operator terminates or adjusts the fermentation. Also, when the controller 25 judges fermentation abnormality, the controller 25 may allow automatic termination or adjustment of the fermentation. This facilitates the judgement whether termination or adjustment of the fermentation is conducted, so that foreign matters/off-flavor can be detected. The fermentation can be adjusted by e.g., mixing of the fermented product, addition of materials or additives to the fermented product, temperature regulation for the fermented product, and stirring regulation of the fermented product, or the like.

The controller 25 can judge fermentation abnormality e.g., when the IMS spectrum shows a peak that is not included in the information under the normal state, when the manner of increase in the peak intensity is significantly different from the information under the normal state, when the peak intensity ratio is significantly different from the information under the normal state, or the like.

FIG. 6 presents IMS spectra under a normal state and an abnormal state. The IMS spectrum under the abnormal state shows a peak that does not appear in the normal state. If such a peak is detected, failure of fermentation or contamination with foreign matters is suspected, and therefore the controller 25 informs the operator the abnormality via the informing portion 27.
Configurations other than those described above are the same as the first through the fifth embodiments. The description on the first through the fifth embodiments applies to the sixth embodiment unless any contradictions occur.

### Seventh Embodiment

The fermentation management method according to the seventh embodiment includes a washing step of removing the fermented product 3 in the fermented product container 2 to wash the fermented product container 2, and a washing validation step conducted after the washing step. In the washing validation step, the gas inside the fermented product container 2 after washing is analyzed by ion mobility spectrometry to validate that the peak intensity or peak area attributed to the residual fermented product or residual detergent is equal to or less than a permissible residual value.

When washing the fermented product tank to make a different product, the residual fermented product 3 and the residual detergent in the fermented product tank may affect the quality of the product. Thus, air in the washed empty fermented product tank is fed as a sample gas together with a carrier gas into the ion mobility spectrometer to perform an ion mobility spectrometry. Then, in the obtained IMS spectrum, it is validated that the IMS intensity of the peak attributed to the residual fermented product 3 or the residual detergent is equal to or less than the permissible residual value. The carrier gas is preferably air having a humidity of 5% or higher.

Configurations other than those described above are the same as the first through the sixth embodiments. The description on the first through the sixth embodiments applies to the seventh embodiment unless any contradictions occur.

Measurement of Substance Produced by Yogurt Fermentation Milk was fermented using a fermented product container as illustrated in FIG. 1 to manufacture yogurt. In the fermentation period, a gas (relative humidity: about 40%) in the headspace of the fermented product container was repeatedly analyzed using the ion mobility spectrometer to obtain IMS spectra for each analysis. A pH of yogurt was measured using a pH electrode.

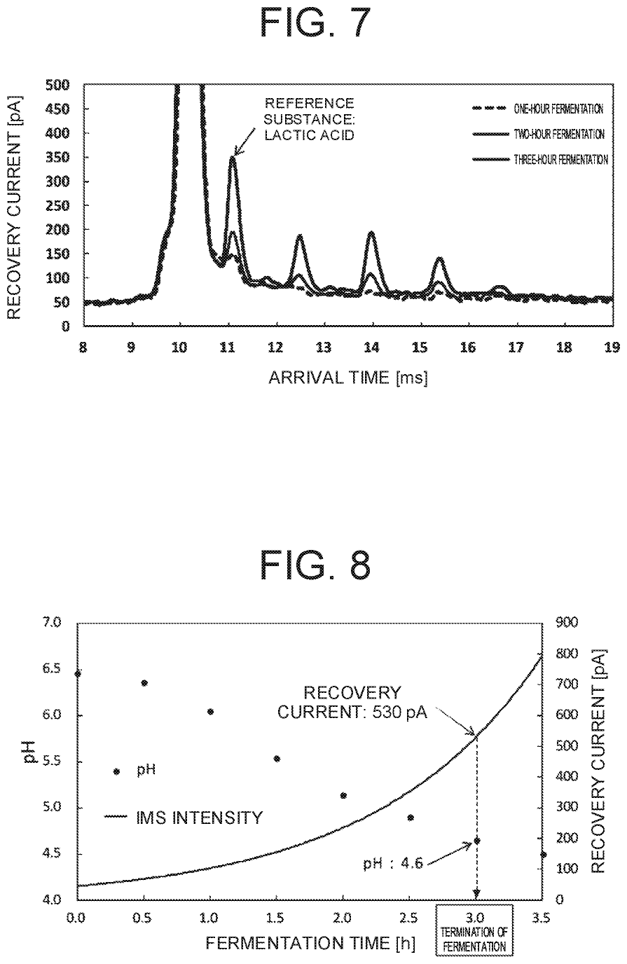

IMS spectra obtained 1, 2, and 3 hours after start of the fermentation are presented in FIG. 7. Each of the obtained IMS spectra showed main peaks at about 10.2 millisecond point, about 11 millisecond point, about 12.5 millisecond point, about 14 millisecond point, and about 15.3 millisecond point. The large peak at 10.2 millisecond point is a peak of ions formed by ionization of air as the carrier gas. The other four peaks are peaks of substances produced in association with the yogurt fermentation, and the peak at 11 millisecond point is considered to be attributed to lactic acid (this peak is possibly a composite peak of lactic acid and other mixed substances). As with the IMS spectrum presented in FIG. 7, the longer the fermentation time was, the higher the peak height of the substance produced in association with the yogurt fermentation was. Thus, it was found that the peak height or peak area could be used as an indicator for progress of the fermentation.

FIG. 8 is a graph indicating change in an IMS intensity (peak height) of a peak (peak at about 11 millisecond point) of an organic acid as a reference substance, and change in a pH of yogurt measured using a pH electrode, during the fermentation. As the fermentation proceeded, the pH gradually decreased, and the IMS intensity gradually increased. Thus, it was found that there was a correlation between the IMS intensity of the organic acid peak and the pH.

It is known that yogurt fermentation can be managed by measuring and monitoring the pH. Thus, by using the correlation as in the graph of FIG. 8, monitoring of the IMS intensity also allows management of the yogurt fermentation.

For example, if the yogurt fermentation is terminated at pH 4.6, the fermentation is terminated at a fermentation time point when the IMS intensity (recovery current) is 530 pA, as indicated in FIG. 8. When the fermentation does not smoothly proceed, a ratio of the IMS intensity with respect to the fermentation time is changed, and therefore quality of the fermentation can be determined at an early stage by monitoring transition in the IMS intensity.

In the case of FIG. 8, the IMS intensity (recovery current) at pH 4.6 was 530 pA, but the IMS intensity varies depending on an output power of the electron emitting element, potential setting of the IMS, a calculation method of the detected current, and the like, and therefore the fermentation may be controlled by a proper IMS intensity value in the measurement.

Preparation of Electron Emitting Element

An electron emitting element as illustrated in FIG. 2 was prepared. An aluminum plate was used for the lower electrode, a silicone resin containing silver particles was used for the intermediate layer, and a gold electrode was used as the surface electrode. The intermediate layer had a thickness of 1.0 μm. An electric circuit as illustrated in FIG. 2 was prepared using the prepared electron emitting element. As a voltage (element driving voltage) applied between the lower electrode and the surface electrode was gradually increased, a recovery current flowing from a counter electrode to the ground (current that flows as electrons are emitted from the electron emitting element) was measured.
A measurement result in the atmosphere is presented in FIG. 9. From this result, it was found that the amount of the electrons emitted from the electron emitting element could be increased by applying a voltage of 8 V or higher between the lower electrode and the surface electrode.

The prepared electron emitting element was incorporated into the ion mobility spectrometer as illustrated in FIG. 1, and ion mobility spectrometry was performed using humidified air as a sample gas.

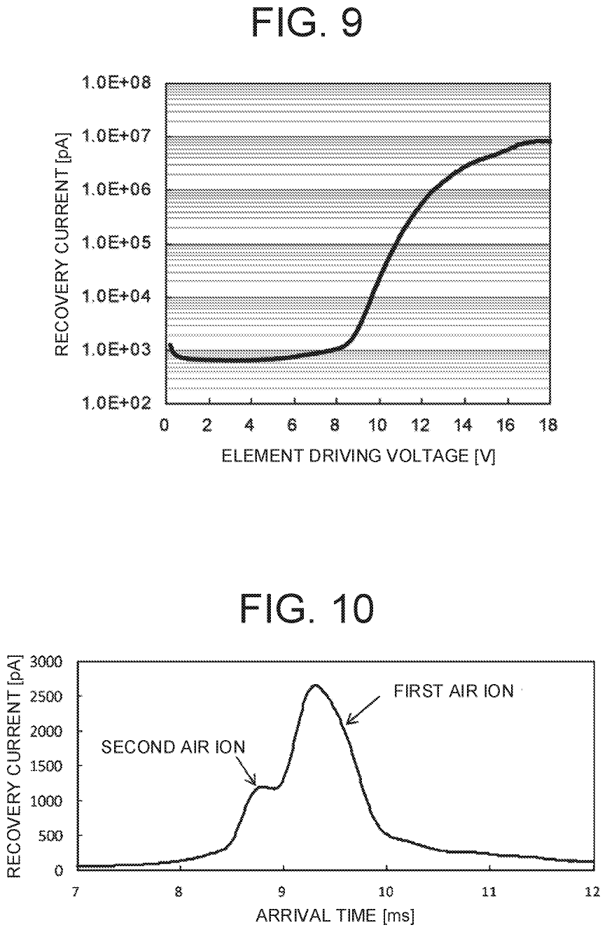

When the element driving voltage was set to 17 V or higher, the IMS spectrum showed a peak of a first air ion as well as a peak of a second air ion as indicated in FIG. 10. In such a way, when there are plural types of air ions, the reaction between the air ions and the sample substance becomes complicated, and the peak intensity of the sample fluctuates in some cases. For that reason, the element driving voltage is preferably 16 V or lower. If the second air ions do not affect quantitativity of the IMS, the element driving voltage can be applied up to 60 V where the electron emitting element is destroyed. However, an amount and energy of electrons emitted from the electron emitting element and a withstand voltage of the element vary depending on the thickness, material, material mixing ratio, driving method, and operation environment of the electron emitting element, and therefore a maximum range of the element driving voltage is set to 6 to 60 V.

What is claimed is:

1. A fermentation management method, comprising
sampling a gas containing substances produced in association with fermentation,
analyzing the sampled gas by ion mobility spectrometry, and
operating at least one of adjustment of the fermentation, termination of the fermentation, mixing of a fermented product, addition of materials or additives to the fermented product, temperature regulation for the fermented product, stirring regulation for the fermented product, firing of the fermented product, sedimentation, and filtration of the fermented product on the basis of at least one of a peak intensity, a peak area, and peak appearance in an IMS spectrum obtained in the analysis, wherein
in the analysis, the substances produced in association with the fermentation are ionized and analyzed by using electrons emitted from an electron emitting element.

2. The fermentation management method according to claim 1, wherein the operation comprises determining an operation timing by comparing the peak intensity, the peak area, or the peak appearance in the IMS spectrum obtained in the analysis with previously measured measurement data on a relationship between a fermented state of the fermented product and the IMS spectrum.

3. The fermentation management method according to claim 1, wherein the fermentation comprises anaerobic fermentation.

4. The fermentation management method according to claim 1, wherein, in the sampling, a gas in a fermented product container is sampled.

5. The fermentation management method according to claim 4, comprising removing the fermented product in the fermented product container to put a detergent liquid into the fermented product container, and flowing the gas in a headspace of the fermented product container containing the detergent liquid into an analysis device for the ion mobility spectrometry.

6. The fermentation management method according to claim 4, comprising removing the fermented product in the fermented product container to wash the fermented product container, and performing washing validation conducted after the washing, wherein
in the washing validation, the gas inside the fermented product container after the washing is analyzed by the ion mobility spectrometry to validate that a peak intensity or peak area attributed to a residual fermented product or a residual detergent is equal to or less than a permissible residual value.

7. The fermentation management method according to claim 1, wherein the electron emitting element has a lower electrode, a surface electrode, and an intermediate layer disposed between the lower electrode and the surface electrode, and emit electrons by applying a voltage between the lower electrode and the surface electrode.

8. The fermentation management method according to claim 7, wherein the intermediate layer has a thickness of 0.5 μm or larger to 2 μm or smaller, and the voltage applied between the lower electrode and the surface electrode in the analysis is 8 V or higher to 16 V or lower.

9. The fermentation management method according to claim 7, wherein the voltage applied between the lower electrode and the surface electrode on the basis of the IMS spectrum in the analysis is regulated.

10. The fermentation management method according to claim 7 further comprising regulating the voltage to be applied between the lower electrode and the surface electrode on the basis of the IMS spectrum obtained by analyzing humidified air.
